(19) United States
(12) Patent Application Publication
(10) Pub. No.: US 2024/0116090 A1
(43) Pub. Date: Apr. 11, 2024

(54) Tank Support Jig and Tank Cleaning Method

(71) Applicant: VALQUA, LTD., Tokyo (JP)

(72) Inventors: Chun Cheng Chen, Kaohsiung (TW); Chi Hsing Fu, Kaohsiung (TW); Katsuyuki Ebisawa, Kaohsiung (TW); Bo Yu Lin, Kaohsiung (TW)

(21) Appl. No.: 18/276,923

(22) PCT Filed: Jan. 28, 2022
(86) PCT No.: PCT/JP2022/003357

§ 371 Date: Aug. 11, 2023

(30) Foreign Application Priority Data
Feb. 18, 2021 (JP) 2021-024432

(51) Int. Cl. B08B 9/08

(52) U.S. Cl. CPC B08B 9/0817; B08B 2209/08

(57) ABSTRACT

Provided are a tank support jig and a tank cleaning method. The tank support jig for supporting a cylindrical tank includes a curved body having a first end and a second end that face with an interval in between; and a connecting member disposed across the interval, the connecting member connecting the first end and the second end of the curved body such that the interval is adjustable, in which the curved body and the connecting member form an annular structure for the tank that is to be placed horizontally inside the annular structure with the curved body in close contact with at least part of an outer circumferential face of the tank along a circumferential direction of the tank.

### CROSS-REFERENCE TO RELATED APPLICATIONS

This application is the United States National Phase of International Application No. PCT/JP2022/003357 filed Jan. 28, 2022, and claims priority to Japanese Patent Application No. 2021-024432 filed Feb. 18, 2021, the disclosures of which are hereby incorporated by reference in their entireties.

### BACKGROUND OF THE INVENTION

### Field of the Invention

The present invention relates to a jig and relates particularly to a tank support jig and a tank cleaning method for cleaning a tank.

### Description of Related Art

In a general semiconductor manufacturing process, a large amount of chemical solution is often used, and the purity of chemical solution is very important for prevention of impurities from staying in a semiconductor device.

Conventionally, chemical solution is manufactured in a chemical plant and then is carried to a semiconductor plant after injected into a tank or is injected into a tank provided in the semiconductor plant, followed by work regarding a semiconductor manufacturing process in the semiconductor plant. Therefore, in order to prevent impurities from staying inside the tank, the tank requires cleaning in advance before chemical solution is injected into the tank. Due to such cleaning, with no impurities contaminating chemical solution, the purity of chemical solution is kept.

Note that, according to a conventional tank cleaning method, as illustrated in FIG. 1A, first, a tank 9′ is made to stand upright, and then the interior of the tank 9′ is cleaned by spraying (with spray 8′ illustrated in FIG. 1A). However, such a tank cleaning method has difficulty not only in cleaning the interior of the tank 9′ uniformly but also in cleaning dirt on the inner-wall face of the tank 9′ because of a very weak degree of spraying. Therefore, after chemical solution is injected into the tank 9′, the impurities remaining inside the tank 9′ are likely to contaminate the chemical solution. In such a case, the purity of chemical solution deteriorates.

Meanwhile, in the industry, there is a method of cleaning the tank 9′ by immersion in cleaning fluid. For example, as illustrated in FIG. 1B, cleaning fluid 8″ is injected into the tank 9′ standing upright up to almost its maximum capacity (90% or more). Then, the impurities in the tank 9′ are dissolved and removed by long immersion, followed by removal of the cleaning fluid 8″.

### SUMMARY OF THE INVENTION

### Technical Problem

However, according to such a conventional method with immersion in cleaning fluid, the cleaning fluid 8″ requires filling up to almost maximum capacity. Thus, a large amount of the cleaning fluid 8″ and long immersion are required, leading to a large increase in the cost of cleaning work and a large increase in the duration of cleaning, namely, a drop in the economic benefit of cleaning work.

Furthermore, according to such a conventional method with immersion in cleaning fluid, from a viewpoint of safety, the cleaning fluid 8″ is not injected up to the upper end space inside the tank 9′. Thus, the upper end space inside the tank 9′ is difficult to clean. Therefore, after chemical solution is injected into the tank 9′, the impurities remaining in the upper end space inside the tank 9′ contaminate the chemical solution, leading to a deterioration in the purity of chemical solution. Thus, the yield of the semiconductor manufacturing is influenced.

Therefore, at present, it is very important to solve such various problems in the conventional technology.

### Solution to Problem

According to the present invention having been made in consideration of such various disadvantages in the conventional technology, provided is a tank support jig for supporting a cylindrical tank, the tank support jig including: a curved body having a first end and a second end that face with an interval in between; and a connecting member disposed across the interval, the connecting member connecting the first end and the second end of the curved body such that the interval is adjustable, in which the curved body and the connecting member form an annular structure for the tank that is to be placed horizontally inside the annular structure with the curved body in close contact with at least part of an outer circumferential face of the tank along a circumferential direction of the tank.

In the tank support jig, the curved body may include a plurality of support portions connected mutually. For example, the plurality of support portions may be detachably connected mutually.

In the tank support jig, the support portions may be each a rod or sheet. The support portions may be each arc-shaped.

In the tank support jig, the connecting member may be horseshoe-shaped.

In the tank support jig, with a screw member, the connecting member may be connected to the first end and the second end of the curved body.

The tank support jig may further include a base on which the curved body is placed. For example, the base may be slidable in contact with an outer circumferential face of the curved body in a circumferential direction such that the tank is allowed to rotate when the tank is placed horizontally inside the annular structure.

According to the present invention, further provided is a tank-support-jig assemblage including a plurality of tank support jigs, in which the plurality of tank support jigs is attached at different positions in an axial direction of the tank.

According to the present invention, provided is a tank cleaning method including: a step of preparing a tank support jig including: a curved body having a first end and a second end that face with an interval in between; and a connecting member disposed across the interval, the connecting member connecting the first end and the second end of the curved body such that the interval is adjustable, the curved body and the connecting member forming an annular structure for a cylindrical tank to be placed horizontally inside the annular structure with the curved body in close contact with at least part of an outer circumferential face of the tank along a circumferential direction of the tank; a step of attaching the tank support jig to a cylindrical tank such that the tank is placed horizontally inside the annular structure with the tank support jig having the annular structure in close contact with at least part of an outer circumferential face of the tank along a circumferential direction of the tank; a step of injecting cleaning fluid into the tank; and a step of cleaning an interior of the tank with the cleaning fluid by rotating, around an axial line of the annular structure, the tank having the tank support jig attached and having the cleaning fluid inside.

In the tank cleaning method, in the step of cleaning, the tank may be caused to pivot backward and forward. For example, with the connecting member as a rotation stopper, the tank may be caused to pivot backward and forward with the rotation stopper as a criterion.

The tank cleaning method may further include a step of placing the curved body of the tank support jig attached to the tank member onto a base slidable in contact with an outer circumferential face of the curved body in a circumferential direction such that the tank is allowed to rotate.

In the tank cleaning method, the step of cleaning may include operating the tank manually to rotate the tank with respect to the base. The base may supply operating force to rotate the tank.

### Advantageous Effects of Invention

As above, mainly with the horizontal placement of the tank and the rotation of the tank in combination, the tank cleaning method according to the present invention enables dissolution and removal of impurities inside the tank due to agitation of the cleaning fluid. Therefore, in comparison to a conventional spray tank cleaning method, the tank cleaning method according to the present invention enables uniform cleaning of any region inside the tank. Strong agitation of the cleaning fluid inside the tank due to a very large rotation force of the tank enables easy cleaning and removal of dirt on the inner-wall face of the tank. Thus, after chemical solution required in a semiconductor manufacturing process is injected into the tank, the chemical solution in the tank is not contaminated with impurities. Thus, with very high purity, the yield of the semiconductor manufacturing process can be secured.

Furthermore, the tank cleaning method according to the present invention enables cleaning work with the horizontal placement of the tank and the rotation of the tank in combination and with cleaning fluid injected up to half the maximum capacity of the tank, leading to a large reduction in the consumption of the cleaning fluid and no requirement of a long-immersion process. Thus, in comparison to a conventional tank cleaning method, the tank cleaning method according to the present invention enables a large reduction in the cost of cleaning work and a reduction in the duration of cleaning, leading to a rise in the economic benefit of cleaning work.

Since the tank cleaning method according to the present invention enables cleaning work with the horizontal placement of the tank and the rotation of the tank in combination and with cleaning fluid injected up to half the maximum capacity of the tank, not only the safety of cleaning work can be achieved but also any region can be cleaned inside the tank. Therefore, in comparison to a conventional immersion tank cleaning method, the tank cleaning method according to the present invention enables no impurities to remain in any region inside the tank after cleaning work. Thus, after chemical solution required in a semiconductor manufacturing process is injected into the tank, the chemical solution in the tank is not contaminated with impurities. Thus, with very high purity, the yield of the semiconductor manufacturing process can be secured.

The tank support jig according to the present invention enables, because of its annular structure, effective distribution of stress to the outer circumferential face of the tank having cleaning fluid injected inside and thus can firmly support the tank having cleaning fluid injected inside with no deformation of the tank.

### BRIEF DESCRIPTION OF THE DRAWINGS

FIG. 1A schematically illustrates a conventional tank cleaning method.

FIG. 1B schematically illustrates another conventional tank cleaning method.

FIG. 2 is a schematic, exploded, and perspective view of a tank support jig according to the present invention.

FIG. 3 is a schematic top view of the tank support jig according to the present invention.

FIG. 4 is a schematic enlarged view of part of FIG. 3.

FIG. 5 is a schematic top view of a connecting member of the tank support jig according to the present invention.

FIG. 6 is a schematic perspective view of a tank-support-jig assemblage according to the present invention having supported a tank.

FIG. 7 is a schematic left side view of the tank-support-jig assemblage according to the present invention having supported the tank.

FIG. 8 is a schematic enlarged view of part of FIG. 7.

FIG. 9 is a schematic front view of the tank-support-jig assemblage according to the present invention having supported the tank.

FIG. 10 is a schematic view of the interior of the tank according to the present invention.

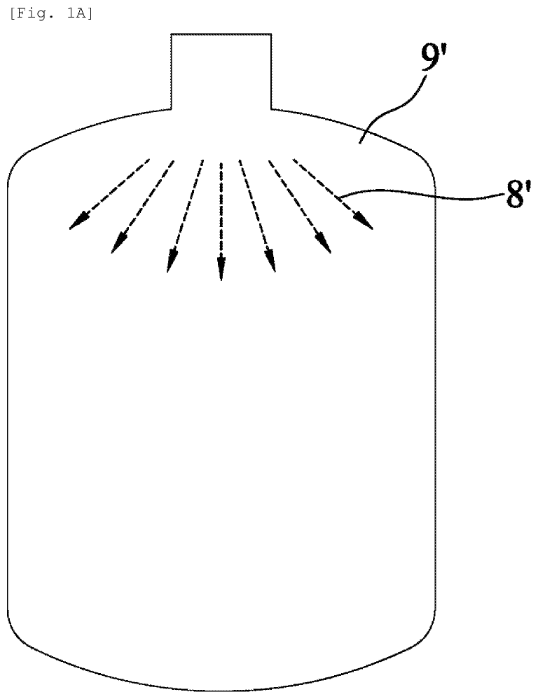

### DESCRIPTION OF THE INVENTION

Specific embodiments of the present invention will be described below.

For example, the structures, proportions, and dimensions in the accompanying drawings of the present specification are given together with the contents in the specification such that those skilled in the technical field that the present invention belongs to can understand easily, and thus do not limit defined conditions enabling embodiments of the present invention. Therefore, any modifications in structure, changes in proportional relationship, or adjustments in dimensions, with substantially no technical meanings, are to be included in the scope of the technical contents disclosed in the present invention, provided that an effect or object of the present invention is not influenced. Furthermore, for example, the terms such as “upper”, “first”, “second”, and “third” in the present specification are given for easy understanding and thus do not limit the scope of embodiments of the present invention. A change or adjustment in the correlation therebetween is to be included in the scope of embodiments of the present invention even in a case where substantially no change is made in the technical contents.

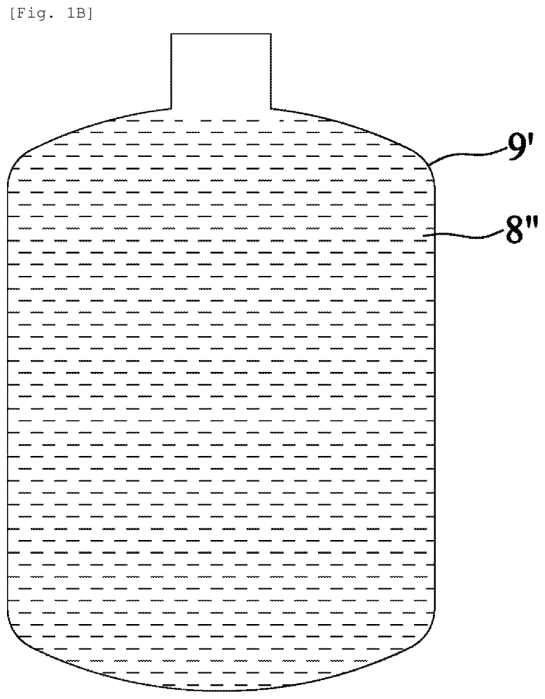

FIGS. 2 to 5 illustrate a tank support jig according to the present invention. As illustrated in FIG. 2, a tank support jig 1 includes a curved body 10 and a connecting member 11.

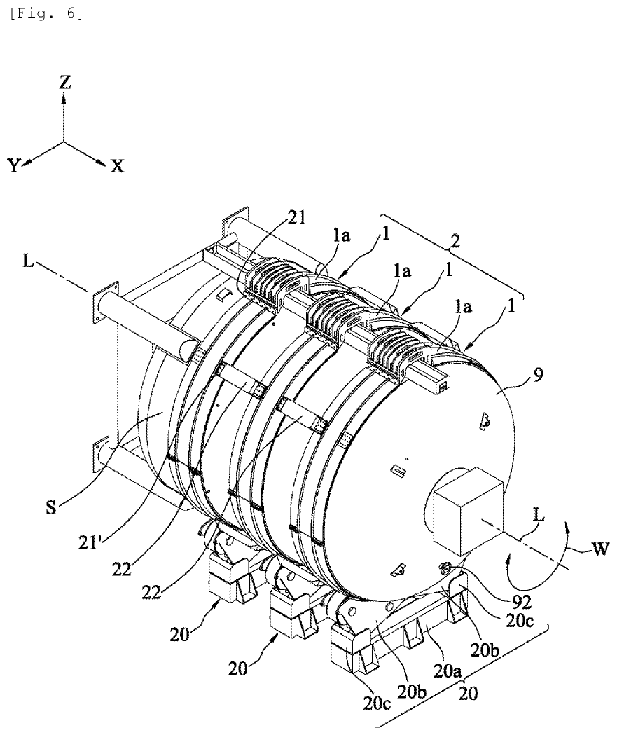

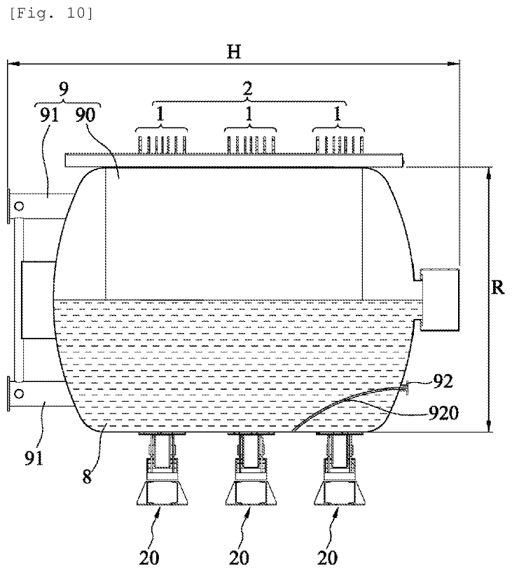

In the embodiment, the tank support jig 1 supports a cylindrical tank 9 (refer to FIG. 6). For example, the tank 9 serves as a storage tank for chemicals and includes, as illustrated in FIG. 10, a tank body 90 of which the outer appearance is substantially cylindrical in shape and legs 91 that support the tank body 90. The tank 9 has a metallic container structure as a standard in which the tank body 90 has a diameter R of 3400 mm and the tank 9 has an overall height H of 5346 mm, resulting in a gross weight of approximately 5 tons. Note that various types of tanks 9 are available and thus the standard is not limiting.

The curved body 10 has a first end 10a and a second end 10b that face with an interval G in between.

In the embodiment, the curved body 10 includes a first support portion 101, a second support portion 102, and a third support portion 103 in mutual connection. For example, the first support portion 101, the second support portion 102, and the third support portion 103 are detachably connected mutually.

An exemplary detachably attachment method is as follows. The first support portion 101, the second support portion 102, and the third support portion 103 each have an end side, as illustrated in FIG. 2, on which at least one plate base 100 having a plurality of through holes 100a is disposed. The plate bases 100 of two mutually adjacent support portions are mutually superposed in alignment. Then, bolts (not illustrated) are inserted through the through holes 100a of the mutually superposed plate bases 100. Then, an end side of each of the bolts is given a nut (not illustrated) for fixation. The superposed plate bases 100 are mutually connected and fixed with the bolts and the nuts, resulting in fixation of the two adjacent support portions. Preferably, the through holes 100a are each a threaded hole. Specifically, both opposed ends of the first support portion 101 are connected, respectively, to the second support portion 102 and the third support portion 103 by bolting.

Furthermore, the curved body 10 is in close contact with at least part of the outer circumferential face S of the tank 9 (refer to FIG. 6) along the circumferential direction W of the tank 9 (refer to FIG. 6). For example, as illustrated in FIG. 2, the curved body 10 has an outer circumferential face C1 on which a single trajectory region A located at an intermediate stage along the circumferential direction of the outer circumferential face C1 and two fixation regions B one-to-one on both sides of the trajectory region A are demarcated. Thus, the curved body 10 rotates due to external force with the trajectory region A, and an enhancement is made in the fixation of the tank 9 with the fixation regions B.

The curved body 10 has an inner circumferential face C2 made of, for example, a soft rubber pad, such as black rubber, for contribution to close contact with the outer circumferential face S of the tank 9.

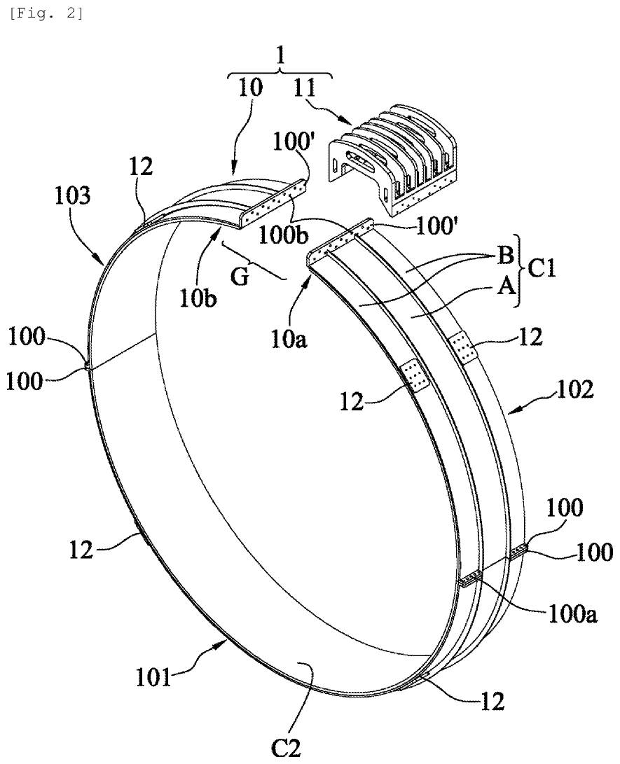

The connecting member 11 is disposed across the interval G and connects the first end 10a and the second end 10b of the curved body 10 such that the width t of the interval G (refer to FIG. 3) can be adjusted. The curved body 10 and the connecting member 11 form an annular structure 1a (refer to FIG. 3), and the tank 9 is placed horizontally inside the annular structure 1a.

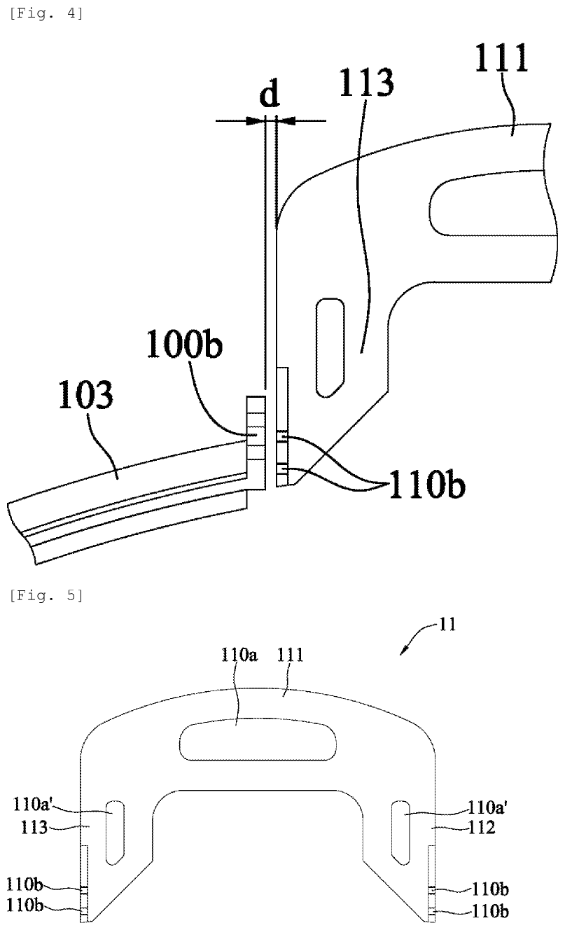

In the embodiment, as illustrated in FIG. 5, the connecting member 11 is horseshoe-shaped in front view and includes a frame body 111 and legs 112 and 113 formed one-to-one on both opposed sides of the frame body 111. For example, the frame body 111 is shaped like a fin or rib, and the fin or rib has at least one opening 110a. The two legs 112 and 113 each have at least one opening 110a′ as necessary. The two legs 112 and 113 each have a side face having a plurality of through holes 110b, for example, as threaded holes.

Furthermore, with a plurality of screw members 21 (refer to FIG. 6), the connecting member 11 is connected to the first end 10a and the second end 10b of the curved body 10, as illustrated in FIG. 2. For example, plate bases 100′, each having a plurality of through holes 100b, for example, as threaded holes, are disposed one-to-one at the first end 10a and the second end 10b of the curved body 10. The respective side faces of the two legs 112 and 113 are superposed one-to-one on the plate base 100′ of the first end 10a and the plate base 100′ of the second end 10b in alignment, followed by coupling with the screw members 21 with the through holes 100b and 110b in correspondence. Thus, the legs 112 and 113 and the plate bases 100′ are connected and fixed with the screw members 21, so that the connecting member 11 and the curved body 10 are fixed together. Specifically, the two legs 112 and 113 of the connecting member 11 are connected, respectively, to the second support portion 102 and the third support portion 103 by screwing.

For example, as illustrated in FIG. 3, the annular structure 1a is formed as an almost torus, in which the first support portion 101 is formed as an arc-shaped segment at an angle of 170° (at a central angle α based on the center O of the annular structure 1a illustrated in FIG. 3). The second support portion 102 and the third support portion 103 each serve as an arc-shaped segment corresponding to an angle required on the basis of the structure or strength of the connecting member 11. Thus, the connecting member 11 can adjust the width t of the interval G, depending on the material characteristic thereof or the degree of fastening of the screw members 21. Thus, the connecting member 11, the second support portion 102, and the third support portion 103 serve as an arch-shaped segment at an angle of 190°. For example, the second support portion 102 and the third support portion 103 serve as arch-shaped segments identical in radian (at a symmetrical angle β of 80° based on the center O of the annular structure 1a illustrated in FIG. 3).

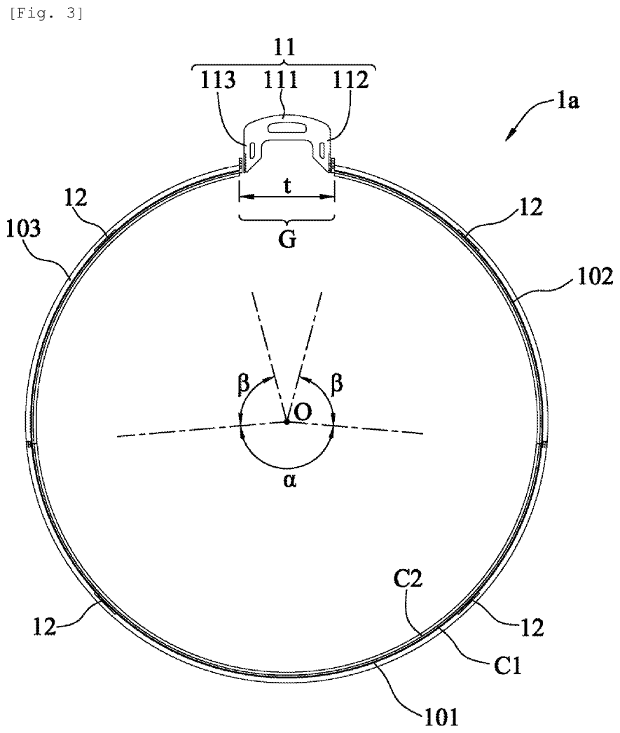

Preferably, a bracket (not illustrated) may be disposed between at least either the leg 112 or leg 113 of the connecting member 11 and the corresponding second support portion 102 or third support portion 103 such that an interval (pitch d illustrated in FIG. 4) is provided between the at least either the leg 112 or leg 113 and the corresponding second support portion 102 or third support portion 103. The bracket disposed in this way would lead to an adjustment in the width t of the interval G, namely, an increase in the width t (for example, the distance between the side faces of the two legs 112 and 113 of the connecting member 11 is added to the pitch d). Note that the at least either the leg 112 or leg 113, the bracket, and the corresponding plate base 100′ are connected and fixed with the screw members 21.

The configuration of the openings 110a and 110a′ is advantageous to stress distribution of the connecting member 11, leading to avoidance of a problem with a crack on the connecting member 11 due to stress concentration. Therefore, in the process of adjustment of the width t of the interval G, the structure of the connecting member 11 can be protected against destruction.

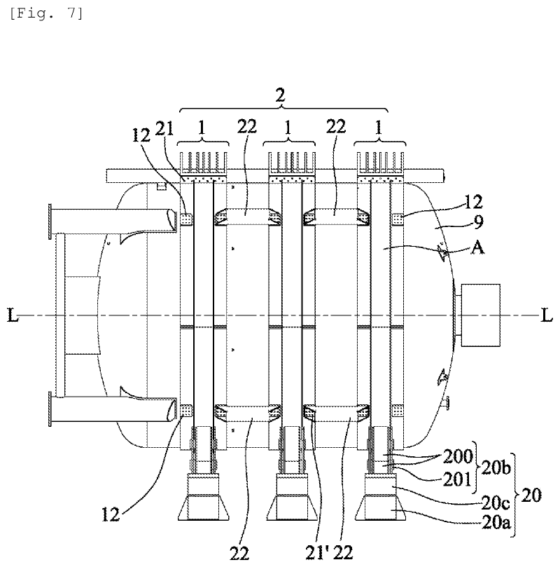

In another embodiment, referring to FIGS. 6 to 9, the tank support jig 1 further includes at least one base 20 for placement of the curved body 10. For example, the base 20 is slidable in contact with the outer circumferential face C1 of the curved body 10 in the circumferential direction such that the tank 9 is allowed to rotate when the tank 9 is placed horizontally in the curved body 10. Specifically, as illustrated in FIG. 7, the base 20 is slidable in contact with the trajectory region A of the curved body 10 such that the curved body 10 can rotate due to external force.

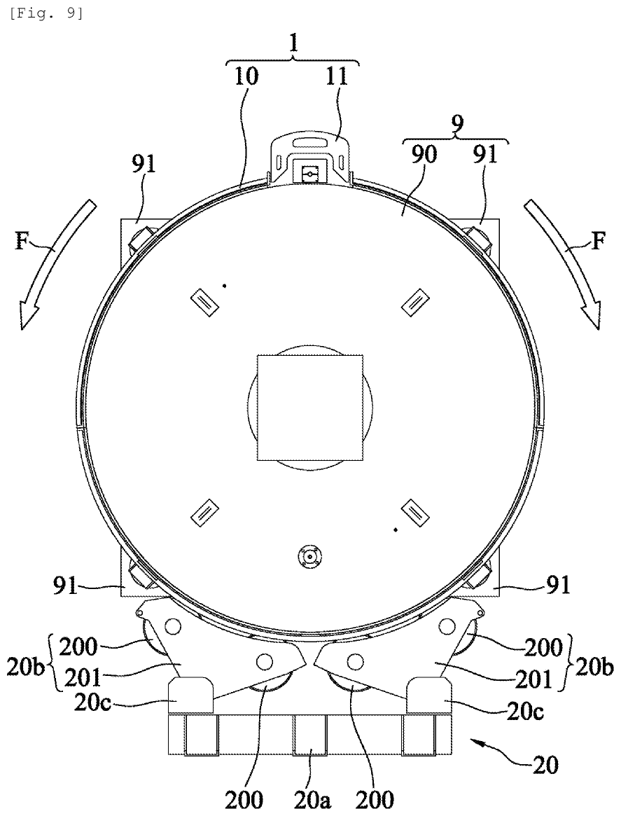

As illustrated in FIG. 6, the base 20 includes a base body 20a and a plurality of functional members 20b provided on the base body 20a. For example, as illustrated in FIG. 9, a single functional member 20b includes two rollers 200 disposed in parallel to the base body 20a through a support holder 201. The support holder 201 is fixed on the base body 20a and the two rollers 200 each have a rotary shaft connected to the support holder 201 such that the two rollers 200 can have contact with the trajectory region A of the curved body 10 (refer to FIG. 7).

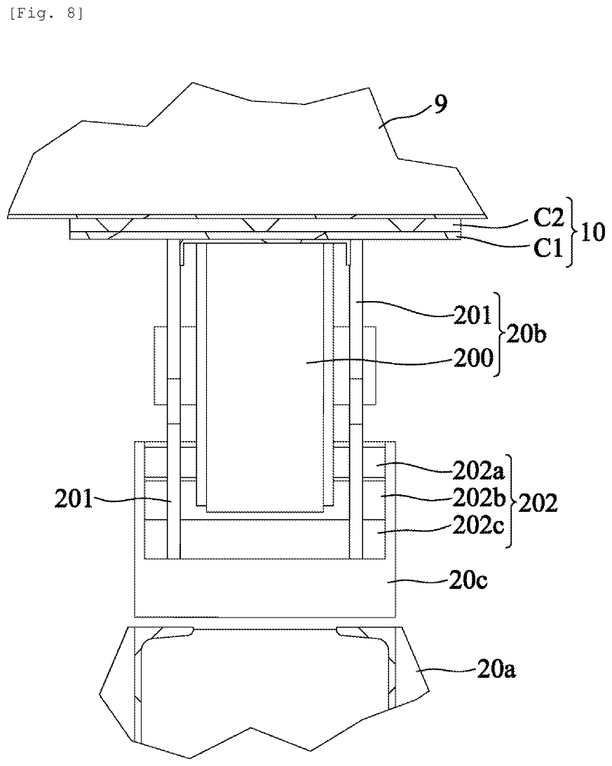

Furthermore, as illustrated in FIG. 9, the functional members 20b are disposed symmetrically on the trajectory region A of the outer circumferential face C1 of the first support portion 101 such that the rollers 200 cause stable rotation of the curved body 10. As illustrated in FIG. 7, preferably, the base body 20a may fix the support holders 201 through a plurality of adjustment members 20c. As illustrated in FIG. 8, each of the adjustment members 20c has a step structure 202 in which the support holder 201 latches together with any one of steps 202a, 202b, and 202c. As necessary, a rise or fall is made in the position of the support holder 201, so that the positions of the rollers 200 can be adjusted in the trajectory region A of the outer circumferential face C1 of the first support portion 101. Thus, the functional members 20b can be each adjusted to a proper position, depending on the degree of radian in the curved body 10.

In another embodiment, as illustrated in FIGS. 6 to 9, a plurality of (e.g., three) tank support jigs 1 can be assembled as a tank-support-jig assemblage 2. The tank support jigs 1 are attached at different positions in the direction of the axial line L of the tank 9. For example, the tank support jigs 1 are arrayed at intervals along the direction of the axial line L of the tank 9. Note that the tank support jigs 1 may be arrayed in close contact as a long-and-cylindrical tank-support-jig assemblage. As necessary, instead of the long-and-cylindrical tank-support-jig assemblage, a single long-and-cylindrical tank support jig may be produced.

The tank-support-jig assemblage 2 includes a plurality of holders 22 each connecting adjacent tank support jigs 1. For example, the holders 22 each have a plurality of fixation holes (denoted with no reference sign) on its both opposed end sides. The tank support jigs 1 each have, in each fixation region B of the outer circumferential face C1 of the curved body 10, a plurality of fixation members 12 (refer to FIG. 2) each having a fixation hole (not illustrated). Each opposed end side of each holder 22 is superposed on a fixation member 12 of the adjacent tank support jig 1 in alignment, followed by coupling with a screw member 21′ with the fixation holes in correspondence. Thus, each holder 22 and the corresponding fixation members 12 are connected and fixed with the screw members 21′, resulting in fixation of the adjacent tank support jigs 1. Specifically, the holders 22 each connect the adjacent first support portions 101, the adjacent second support portions 102, or the adjacent third support portions 103 by screwing.

Furthermore, for adjustment of the structural strength of the tank-support-jig assemblage 2, as necessary, adjustments can be made in the positions of arrangement of the fixation members 12. For example, based on the annular structure 1a illustrated in FIG. 3, the fixation members 12 can be disposed symmetrically or uniformly in the corresponding fixation region B of the outer circumferential face C1 of the curved body 10.

For example, four places at angles of 90° around the center O illustrated in FIG. 3 can be each provided with a fixation member 12. The first support portion 101 has fixation members 12 disposed one-to-one at two of the four places. The second support portion 102 and the third support portion 103 each have a fixation member 12 disposed at one place thereof. As illustrated in FIG. 9, preferably, the tank 9 has its four legs 91 corresponding one-to-one to the positions of the fixation members 12.

Note that, as necessary, a selection can be made in the type of tank support jig 1. For example, a change may be made to the curved body 10 having a single, two, or four or more arch-shaped segments. A change may be made in the form of the connecting member 11. Thus, the above form is not limiting.

For use of the tank support jig 1, as illustrated in FIG. 6, a tank 9 is placed horizontally inside the annular structure 1a in close contact with the inner circumferential face C2 of the curved body 10. External force moves the curved body 10 rotationally, so that the tank support jig 1 rotates in contact with the rollers 200. Thus, the tank support jig 1 can be applied to cleaning work to the tank 9.

Thus, referring to FIGS. 2 to 10, according to the present invention, further provided is a tank cleaning method for cleaning work to the tank 9. A specific process of the tank cleaning method used in the cleaning work is as follows.

In the embodiment, for usage of the tank support jig 1, with the placement surface of the base 20 as a criterial face (e.g., environmental surface, such as the ground), the direction of placing the tank 9 horizontally is defined as a front-back direction (namely, the direction of the axial line L of the tank 9, for example, an arrow direction X illustrated in FIG. 6), and the other coordinate axis of the criterial face is defined as a left-right direction (e.g., an arrow direction Y illustrated in FIG. 6). Furthermore, the direction of upright standing of the tank 9 before being placed horizontally is defined as an up-down direction (direction orthogonal to the criterial face, for example, an arrow direction Z illustrated in FIG. 6).

First, the first support portion 101 is disposed on the base 20 and then the tank 9 is placed horizontally on the first support portion 101 by leaning. Next, the second support portion 102 and the third support portion 103 are connected and fixed to the first support portion 101. Furthermore, the second support portion 102 and the third support portion 103 are connected and fixed with the connecting member 11, resulting in formation of an annular structure 1a. Thus, as illustrated in FIG. 6, the annular structure 1a is in close contact with at least part of the outer circumferential face S of the tank 9 along the circumferential direction W of the tank 9, resulting in achievement of the tank support jig 1. Then, the tank 9 is fixed horizontally by the tank-support-jig assemblage 2.

Next, as illustrated in FIG. 10, cleaning fluid 8 is injected into the tank body 90 of the tank 9 through an inlet port 92 of the tank 9. The cleaning fluid 8 is not injected up to the maximum capacity of the tank body 90 of the tank 9 but injected up to approximately half the maximum capacity. For example, an inlet tube 920 inside the tank body 90 is connected to the inlet port 92. Thus, the cleaning fluid 8 is injected into the tank body 90 through the inlet tube 920.

In the embodiment, the cleaning fluid 8 contains hydrogen peroxide accounting for 31% and having a density of 1.11 g/cm³. The cleaning fluid 8 is, at its maximum, half the maximum capacity of the tank body 90 (approximately 20 tons in weight). Thus, at the time of rotation of the tank support jig 1 in contact with the rollers 200, the cleaning fluid 8 shakes inside the tank body 90.

Note that, as another process, before the tank 9 is leaned, first, the cleaning fluid 8 may be injected into the tank body 90 and then the tank 9 may be placed horizontally on the first support portion 101 by leaning.

After that, the curved body 10 moves rotationally, for example, due to external force such as manual external force or electrical external force. Thus, the tank 9 having the cleaning fluid 8 injected inside and being provided with the tank support jig 1 (or the tank-support-jig assemblage 2) rotates around the axial line L of the tank 9 as a rotation axis, so that the cleaning fluid 8 shakes inside the tank body 90. Due to the cleaning fluid 8 shaking as above, the interior of the tank body 90 is cleaned.

In the embodiment, the connecting member 11 is not allowed to slide over the rollers 200 of the base 20. Thus, the tank 9 is not allowed to make one rotation although the tank 9 is allowed to pivot in the left direction (counterclockwise) or in the right direction (clockwise) with the connecting member 11 as a starting point, for example, in either rotation direction F illustrated in FIG. 9. For example, the tank 9 has a rotation angle enabling a pivot in the left direction by an angle of approximately 130° and a pivot in the right direction by an angle of approximately 130° around the rotation axis, namely, a large pivot by an angle of 260° from lower left to lower right or from lower right to lower left. Therefore, in the cleaning process, the tank 9 is allowed to pivot backward and forward, namely, pivot counterclockwise and clockwise. Note that the rotation angle of the tank 9 is determined by the dimensions of the connecting member 11 and the base 20, and thus an adjustment in the dimensions of the connecting member 11 and the base 20 enables a change in the rotation angle of the tank 9.

After cleaning work, the cleaning fluid 8 is extracted from the tank body 90 through the inlet port 92 of the tank 9 with the inlet tube 920, followed by transport to a predetermined place outside the tank 9, such as a waste-fluid collecting station (not illustrated).

Therefore, mainly with the horizontal placement of the tank 9 and the rotation of the tank 9 in combination, the tank cleaning method according to the present invention enables dissolution and removal of impurities inside the tank 9 due to agitation of the cleaning fluid 8. Therefore, in comparison to a conventional spray cleaning method, the tank cleaning method according to the present invention enables effective and uniform cleaning of any region inside the tank body 90 of the tank 9 because of the rotation angle of the tank 9. Strong agitation of the cleaning fluid 8 inside the tank due to a large rotation force of the tank 9 enables easy cleaning and removal of dirt on the inner-wall face of the tank body 90 of the tank 9. Thus, after chemical solution required in a semiconductor manufacturing process is injected into the tank body 90 of the tank 9, the chemical solution in the tank body 90 of the tank 9 is not contaminated with various types of impurities. Thus, with high purity, the yield of the semiconductor manufacturing process can be secured.

Furthermore, in comparison to a conventional immersion cleaning method, the tank cleaning method according to the present invention enables cleaning work with the horizontal placement of the tank 9 and the rotation of the tank 9 in combination and with the cleaning fluid 8 injected up to half the maximum capacity of the tank body 90 in the tank body 90 of the tank 9. Thus, a large reduction can be made in the consumption of the cleaning fluid 8 and no long-immersion process is required. Therefore, the tank cleaning method according to the present invention enables a large reduction in the cost of cleaning work and a reduction in the duration of cleaning, leading to a rise in the economic benefit of cleaning work.

In comparison to the conventional immersion cleaning method, since the tank cleaning method according to the present invention enables cleaning work with the horizontal placement of the tank 9 and the rotation of the tank 9 in combination and with cleaning fluid injected up to half the maximum capacity of the tank body 90 in the tank body 90 of the tank 9, not only an enhancement can be made in the safety of cleaning work but also any region can be cleaned inside the tank body 90 of the tank 9. Therefore, the tank cleaning method according to the present invention enables no impurities to remain in any region inside the tank body 90 of the tank 9 after cleaning work. Thus, after chemical solution required in a semiconductor manufacturing process is injected into the tank body 90 of the tank 9, the chemical solution in the tank body 90 of the tank 9 is not contaminated with various types of impurities. Thus, with high purity, a high yield can be secured in the semiconductor manufacturing.

In accordance with the requirement of the tank cleaning method according to the present invention, mainly due to the configuration of the annular structure 1a, the tank support jig 1 (or the tank-support-jig assemblage 2) according to the present invention enables an enhancement in resistance against deformation at the time of horizontal placement or rotation of the tank 9 (namely, the strength-assist function of the tank support jig 1 or the tank-support-jig assemblage 2) and effective distribution of stress to the outer circumferential face S of the tank 9 having the cleaning fluid 8 injected inside (e.g., the centrifugal force in rotation), leading to no problem with stress concentration. Therefore, the tank support jig 1 (or the tank-support-jig assemblage 2) can firmly support the tank 9 having the cleaning fluid 8 injected inside (gross weight of approximately 25 tons), leading to no deformation of the tank 9 (regardless of whether or not the cleaning fluid 8 has been injected).

Furthermore, due to the configuration of the base 20, the tank support jig 1 (or the tank-support-jig assemblage 2) according to the present invention distributes stress to the outer circumferential face S at the time of rotation of the tank 9. In particular, the adoption of a configuration in which the weight of the tank 9 is supported by four rollers 200 enables further distribution of stress to the outer circumferential face S located closer to the rollers 200 of the tank 9 having the cleaning fluid 8 injected inside. Therefore, the tank support jig 1 (or the tank-support-jig assemblage 2) can firmly support the tank 9 having the cleaning fluid 8 injected inside, leading to no deformation of the tank 9.

As above, the tank support jig and the tank cleaning method according to the present invention enable achievement of cleaning work having a high cleaning effect and a reduction in the duration of cleaning, with a configuration in which, for example, a tank placed horizontally is supported by the tank support jig having an annular structure and is rotated. Thus, for example, a reduction can be made in the time for starting a semiconductor wafer manufacturing process (period for launching a production line), leading to contribution to the technical development of a semiconductor manufacturing process.

Furthermore, according to the horizontal placement-and-rotation cleaning process of the present invention, cleaning fluid is required to be injected, at its maximum, up to half the maximum capacity of the tank. Thus, not only a reduction can be made in the cost of cleaning fluid but also a reduction can be made in the amount of cleaning fluid discharged in the cleaning work (namely, waste fluid), leading to a large reduction in the cost of waste fluid disposal.

The embodiments described above are just exemplary for the principle and effect of the present invention. It is conceivable that those skilled in the technical field that the present invention belongs to will make various modifications or alterations in the embodiments without departing from the gist of the present invention. Therefore, the present invention is not limited to the given embodiments and thus should be construed with the widest scope of the technical idea defined based on the scope of the claims.

### REFERENCE SIGNS LIST

1 Tank support jig
1a Annular structure
10 Curved body
10a First end
10b Second end
100, 100′ Plate base
100a, 100b, 110b Through hole
101 First support portion
102 Second support portion
103 Third support portion
11 Connecting member
110a, 110a′ Opening
111 Frame body
112, 113 Leg
12 Fixation member
2 Tank-support-jig assemblage
20 Base
20a Base body
20b Functional member
20c Adjustment member
200 Roller
201 Support holder
202 Step structure
202a, 202b, 202c Step
21, 21′ Screw member
22 Holder
8, 8″ Cleaning fluid
8′ Spray
9 Tank
9′ Tank
90 Tank body
91 Leg
92 Inlet port
920 Inlet tube
α Central angle
β Symmetrical angle
A Trajectory region
B Fixation region
C1 Outer circumferential face
C2 Inner circumferential face
d Pitch
F Rotation direction
G Interval
H Height
L Axial line
O Center
R Diameter
S Outer circumferential face
t Width
W Circumferential direction
X, Y, Z Arrow direction

1. A tank support jig for supporting a cylindrical tank, the tank support jig comprising:
a curved body having a first end and a second end that face with an interval in between; and
a connecting member disposed across the interval, the connecting member connecting the first end and the second end of the curved body such that the interval is adjustable, wherein
the curved body and the connecting member form an annular structure for the tank that is to be placed horizontally inside the annular structure with the curved body in close contact with at least part of an outer circumferential face of the tank along a circumferential direction of the tank.

2. The tank support jig according to claim 1, wherein the curved body includes a plurality of support portions connected mutually.

3. The tank support jig according to claim 2, wherein the plurality of support portions is detachably connected mutually.

4. The tank support jig according to claim 1, wherein the connecting member is horseshoe-shaped.

5. The tank support jig according to claim 1, wherein, with a screw member, the connecting member is connected to the first end and the second end of the curved body.

6. The tank support jig according to claim 1, further comprising a base on which the curved body is placed.

7. The tank support jig according to claim 6, wherein the base is slidable in contact with an outer circumferential face of the curved body in a circumferential direction such that the tank is allowed to rotate when the tank is placed horizontally inside the annular structure.

8. A tank-support-jig assemblage comprising a plurality of the tank support jigs according to claim 1, wherein the plurality of the tank support jigs is attached at different positions in an axial direction of the tank.

9. A tank cleaning method comprising:
a step of preparing a tank support jig including:
a curved body having a first end and a second end that face with an interval in between; and
a connecting member disposed across the interval, the connecting member connecting the first end and the second end of the curved body such that the interval is adjustable,
the curved body and the connecting member forming an annular structure for a cylindrical tank to be placed horizontally inside the annular structure with the curved body in close contact with at least part of an outer circumferential face of the tank along a circumferential direction of the tank;
a step of attaching the tank support jig to a cylindrical tank such that the tank is placed horizontally inside the annular structure with the tank support jig having the annular structure in close contact with at least part of an outer circumferential face of the tank along a circumferential direction of the tank;
a step of injecting cleaning fluid into the tank; and
a step of cleaning an interior of the tank with the cleaning fluid by rotating, around an axial line of the annular structure, the tank having the tank support jig attached and having the cleaning fluid injected inside.

10. The tank cleaning method according to claim 9, wherein in the step of cleaning, the tank is caused to pivot backward and forward.
